(19) United States
(12) Patent Application Publication
(10) Pub. No.: US 2010/0064280 A1
(43) Pub. Date: Mar. 11, 2010

(54) SYSTEMS AND METHODS FOR IMPLEMENTING TEST APPLICATIONS FOR SYSTEMS USING LOCKS

(75) Inventors: Aviad Zlotnick, Mitzpeh Netofah (IL); Eitan Farchi, Pardes Hana (IL); Yarden Nir-Buchbinder, Haifa (IL)

Correspondence Address: McGinn Intellectual Property Law Group, PLLC, 8321 Old Courthouse Road, Suite 200, Vienna, VA, 22182-3817, US

(73) Assignee: International Business Machines Corporation, Armonk, NY (US)

(21) Appl. No.: 12/206,813

(22) Filed: Sep. 9, 2008

(51) Int. Cl. G06F 9/44

(52) U.S. Cl. 717/124

(57) ABSTRACT

A method of testing a system includes providing a shared memory including at least one value and at least one lock associated with the at least one value, the at least one lock including one or more shared read sublocks and an exclusive write sublock, providing a plurality of subsystems in communication with the shared memory and configured to access and update the at least one value, providing a test application on at least one of the plurality of subsystems, and running the test application on the one of the plurality of subsystems. A list of locks and values given to the test application includes a pre-existing list of locks and values in the system under the testing.

### BACKGROUND OF THE INVENTION

1. Field of the Invention

The present invention generally relates to systems and methods for implementing test applications of systems using locks.

2. Description of the Related Art

Multiples systems and processes may all use a common value. For example, a counter including a single value may be accessed and updated by multiple processes. A problem may arise when multiple processes attempt to simultaneously access and update the single value. In the scenario of a simple counter, the single value may merely increase by one each time a process accesses and updates the single value. Thus, if the single value is at 5, and two processes access the single value, the single value should change to 7. If, however, the two processes access and update the single value substantially simultaneously or close together in time, they may both return a single value of 6, in which case the counter is off by one.

One way to solve this problem may be to implement a lock associated with the single value. The lock may be configured such that if a process wishes to access and/or update the single value, the process must first take the lock. If the lock is taken by a process, another process, when it attempts to access and/or update the single value, will fail because it cannot acquire the lock. However, problems sometimes arise during testing where it is difficult to simulate when a lock is taken by a process, and thus the system cannot be placed under similar stress that it would be under during normal operation. This may prevent the identification and diagnosis of problems until the system is actually being used by the consumer, which is undesirable from a customer relations standpoint.

### SUMMARY OF THE INVENTION

In view of the foregoing and other exemplary problems, drawbacks, and disadvantages of the conventional methods and structures, an exemplary feature of the present invention is to provide systems and methods for implementing test applications of systems using locks.

Another exemplary feature of the present invention is a system including a plurality of subsystems and a shared memory for implementing any method set forth herein.

An exemplary embodiment of the present invention includes a method of testing a system. The method includes providing a shared memory including at least one value and at least one lock associated with the at least one value, the at least one lock including one or more shared read sublocks and an exclusive write sublock, providing a plurality of subsystems in communication with the shared memory and configured to access and update the at least one value, providing a test application on at least one of the plurality of subsystems, and running the test application on the one of the plurality of subsystems. The test application comprises providing a predetermined list including a plurality of entries, each entry including a lock identification, randomly choosing one of the plurality of entries, randomly choosing one of one or more shared read sublocks and an exclusive write sublock of a lock associated with the lock identification of the one of the plurality of entries, determining whether the one of the one or more shared read sublocks and the exclusive write sublock is available, if the one of the one or more shared read sublocks and the exclusive write sublock is available, acquiring the one of the one or more shared read sublocks and the exclusive write sublock, if the one of the one or more shared read sublocks and the exclusive write sublock is not available, waiting for the one of the one or more shared read sublocks and the exclusive write sublock to become available, holding the one of the one or more shared read sublocks and the exclusive write sublock for a period of time, and releasing the one of the one or more shared read sublocks and the exclusive write sublock.

Another exemplary embodiment of the present invention includes a computer readable medium tangibly embodying a program for executing any method set forth herein.

### BRIEF DESCRIPTION OF THE DRAWINGS

The foregoing and other exemplary purposes, aspects and advantages will be better understood from the following detailed description of an exemplary embodiment of the invention with reference to the drawings, in which:

FIG. 1 illustrates a system including multiple subsystems and a shared memory according to an exemplary embodiment of the invention;

FIG. 2 illustrates an exemplary method of implementing the system of FIG. 1;

FIG. 3 illustrates an exemplary subprocess of the method of FIG. 2; and

FIG. 4 illustrates another exemplary subprocess of the method of FIG. 2

### DETAILED DESCRIPTION OF EXEMPLARY EMBODIMENTS OF THE INVENTION

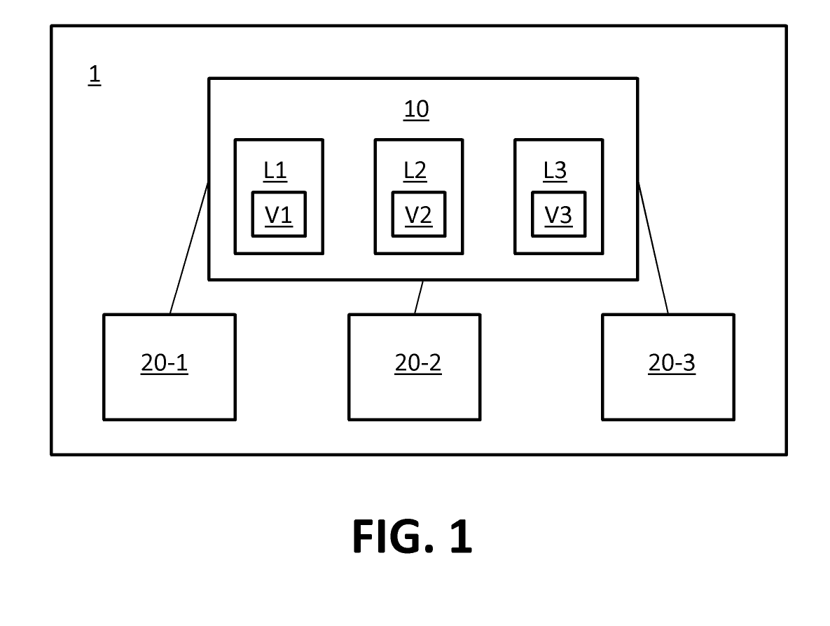

FIG. 1 discloses an exemplary embodiment of system 1 according to an aspect of the present invention. System 1 may include shared memory 10 and a plurality of subsystems 20-1, 20-2, 20-3. System 1 may be contained within one computer system or its components may be distributed across several computer systems. For example, each of subsystems 20-1, 20-2, 20-3 may be disposed on one computer, distributed across several computers, or even distributed across several servers or networks.

Shared memory 10 may include a plurality of modified values V1, V2, V3 with corresponding locks L1, L2, L3. Locks L1, L2, L3 may be configured such that only one of subsystems 20-1, 20-2, 20-3 can access and/or update the corresponding modified value V1, V2, V3 at any given time. In various embodiments, shared memory 10 may be a plurality of shared memories including any number or subset of modified values V1, V2, V3 with corresponding locks L1, L2, L3.

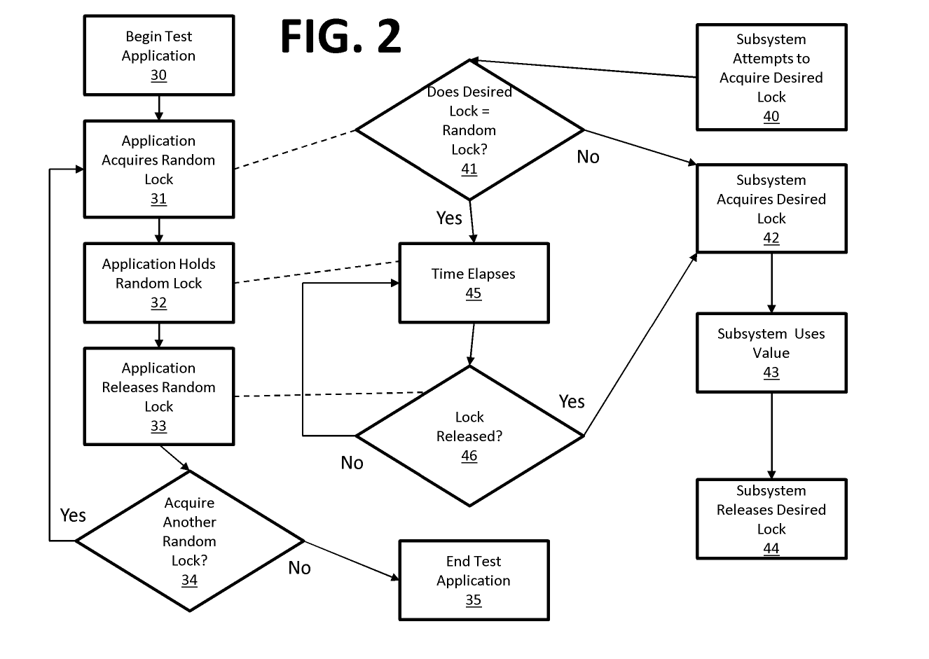

FIG. 2 illustrates an exemplary method of implementing system 1. The method may begin in Step 30 when one of subsystems 20-1, 20-2, 20-3, for example, subsystem 20-1 runs a test application for testing system 1. The test application may begin by randomly acquiring one of the available locks L1, L2, L3 in Step 31, for example, lock L1. Lock L1, L2, L3 is available if another subsystem 20-2, 20-3 has not acquired lock L1, L2, L3. The effect of the test application on subsystem 20-1 holding lock L1 is that the other subsystems 20-2, 20-3 are prevented from acquiring lock L1 and accessing and/or updating value V1. The test application may then hold lock L1 for a period of time in Step 32. In Step 33, after holding lock L1, the test application running on subsystem 20-1 may release lock L1 such that other subsystems 20-2, 20-3 may acquire lock L1 so as to access and/or update value V1. At Step 34, the test application running on subsystem 20-1 may decide whether to acquire another lock L1, L2, L3. If so, then the process returns to Step 31. If not, then the process ends at Step 35.

Concurrently while Steps 30-35 are being performed by the test application on subsystem 20-1, one of subsystems 20-1, 20-2, 20-3, for example, subsystem 20-2, may desire to access and/or update one of values V1, V2, V3, for example, value V1. In order to access and/or update value V1, subsystem 20-2 may attempt to acquire lock L1 in Step 40. In Step 41, subsystem 20-2 may determine whether lock L1 has been acquired, for example, by the test application running on subsystem 20-1. In practice, however, subsystem 20-1 will have no way of determining whether the test application has acquired lock L1. The subsystem 20-1 will simply determine that another subsystem 20-1, 20-3 has acquired lock L1 because lock L1 is not available.

If subsystem 20-2 determines that lock L1 is available, subsystem 20-2 acquires lock L1 in Step 42, accesses and updates value V1 in Step 43, and then releases lock L1 in Step 44.

If subsystem 20-2 determines that lock L1 is not available in Step 41, subsystem 20-2 merely waits in Step 45 while the test application implements Step 32, and periodically checks in Step 46 whether lock L1 has been released. If lock L1 has not been released by the test application of subsystem 20-1, the process in subsystem 20-2 loops back to Step 45. Otherwise, the process in subsystem 20-2 proceeds to Step 42.

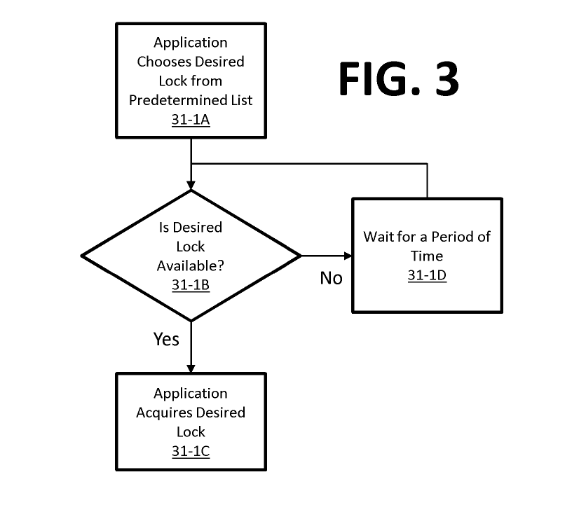

FIG. 3 illustrates an exemplary subprocess of FIG. 2. Specifically, FIG. 3 goes into more detail concerning the implementation of Step 31. In Step 31-1A, the test application running on subsystem 20-1 chooses a desired lock L1, L2, L3 from a predetermined list, for example, lock L1. In Step 3I-1B, the test application determines whether lock L1 is available. If lock L1 is available, the test application acquires the desired lock in Step 31-1C. If lock L1 is not available, however, the test application proceeds to Step 31-1D and waits for a period of time before proceeding back to Step 31-1B to see if lock L1 has become available. This succession continues until lock L1 becomes available before proceeding to Step 31-1C. The predetermined list may include individual entries having one or more of the following fields:

Lock identification (name and/or address and/or code location);

Duration of holding lock; and

Weight.

The lock identification may include any of locks L1, L2, L3 and corresponding relevant information, for example, the location of lock L1, L2, L3 on shared memory 10. The duration of hold is the period of time during which lock L1, L2, L3 is held by the test application running on one of subsystems 20-1, 20-2, 20-3. This field corresponds to Step 31 in FIG. 2. The weight is to determine which of locks L1, L2, L3 is randomly chosen by the test application for acquisition and holding. For example, it may be desirable to acquire lock L1 more than lock L2. In such a case, the weight associated with lock L1 may be greater than the weight associated with lock L2. The test application may have a randomizer which takes the weights into account when randomly deciding which lock L1, L2, L3 to choose for acquisition.

The predetermined list may include any list of locks L1, L2, L3 acquired using any suitable method. For example, the predetermined list may be generated by an individual user. In another example, the predetermined list may be automatically generated, for example, by one of subsystems 20-1, 20-2, 20-3. The automatically generated list may take into account which of locks L1, L2, L3 is acquired by subsystems 20-1, 20-2, 20-3 and/or the frequency they are acquired by subsystems 20-1, 20-2, 20-3 in determining any of the fields of the individual entries. The automatically generated list may by updated concurrently with the testing and operation of system 1, for example, to provide better real-time data and weighting.

The predetermined list generated by the individual user may be advantageous over the automatically generated list because the automatically generated list may overlook locks L1, L2, L3 that are acquired as often and/or are not acquired at all. This may prevent errors associated with the overlooked locks L1, L2, L3 from being identified. The individual user may simply include those locks L1, L2, L3 in the predetermined list and provide them with a disproportionate weight relative to their acquisition rate.

The automatically generated list may be advantageous over the predetermined list generated by the individual user because the individual user may make errors in creating individual entries of the predetermined list, may fail to include some locks L1, L2, L3 that are frequently used, and/or may not properly simulate real world uses of system 1 as the automatically generated list would.

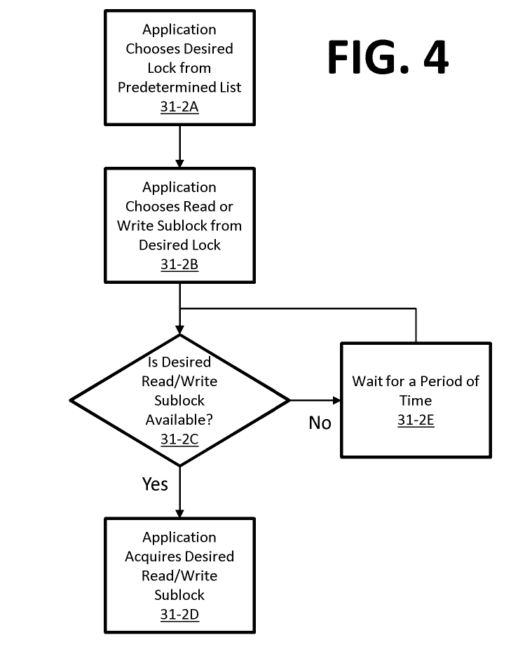

FIG. 4 illustrates another exemplary subprocess of FIG. 2 different from the exemplary subprocess of FIG. 3. Specifically, the main difference is that each lock L1, L2, L3 also includes sublocks, for example, one or more shared read sublocks and an exclusive write sublock. For the one or more shared read sublocks, different subsystems 20-1, 20-2, 20-3 may each acquire one of the one or more shared read sublocks, if more than one is available, such that each of subsystems 20-1, 20-2, 20-3 may access the same value V1, V2, V3. However, none of subsystems 20-1, 20-2, 20-3 may update value V1, V2, V3 while only the one or more shared read sublocks have been acquired.

In order to update value V1, V2, V3, subsystems 20-1, 20-2, 20-3 must acquire the exclusive write sublock of corresponding lock L1, L2, L3. However, only one of subsystems 20-1, 20-2, 20-3 may acquire the exclusive write sublock of corresponding lock L1, L2, L3 at any given time. One of subsystems 20-1, 20-2, 20-3 may also acquire the exclusive write sublock of corresponding lock L1, L2, L3 merely to access value V1, V2, V3 and prevent other subsystems 20-1, 20-2, 20-3 from accessing or updating value V1, V2, V3.

For this embodiment, in Step 31-2A, the test application running on subsystem 20-1 chooses a desired lock L1, L2, L3 from a predetermined list, for example, lock L1. In Step 31-2B, the test application then determines whether it desires to acquire the exclusive write sublock or one of the one or more shared read sublocks of lock L1. Once the test application has chosen one of the exclusive write sublock and the one of the one or more shared read sublocks of lock L1, for example, the one of the one or more shared read sublocks, the test application determines whether the one of the one or more shared read sublocks of lock L1 is available in Step 31-2C. If the one of the one or more shared read sublocks of lock L1 is available, the test application acquires the desired sublock in Step 31-2D. If the one of the one or more shared read sublocks of lock L1 is not available, however, the test application proceeds to Step 31-2E and waits for a period of time before proceeding back to Step 31-2C to see if the one of the one or more shared read sublocks of lock L1 has become available. This succession continues until the one of the one or more shared read sublocks of lock L1 becomes available before proceeding to Step 31-2D. The predetermined list used for the subprocess set forth in FIG. 4 may include individual entries having one or more of the following fields:

Lock identification (name and/or address and/or code location);

Duration of holding lock for read;

Duration of holding lock for write;

Ratio between read and write accesses; and

Weight.

The lock identification may include any of locks L1, L2, L3 and corresponding relevant information, for example, the location of lock L1, L2, L3 on shared memory 10. The separate duration of hold fields for reading and writing are the period of time during which the one or more shared read sublocks or the exclusive write sublock of lock L1, L2, L3 is held by the test application running on one of subsystems 20-1, 20-2, 20-3. This field corresponds to Step 31 in FIG. 2. The weight is to determine which of locks L1, L2, L3 is randomly chosen by the test application for acquisition and holding. For example, it may be desirable to acquire lock L1 more than lock L2. In such a case, the weight associated with lock L1 may be greater than the weight associated with lock L2. The test application may have a randomizer which takes the weights into account when randomly deciding which lock L1, L2, L3 to choose for acquisition. The ratio is similar to weight in that it is to determine which of the one or more shared read sublocks and exclusive write sublock of the chosen lock L1, L2, L3 is randomly chosen by the test application for acquisition and holding. For example, it may be desirable to acquire one or more shared read sublock of lock L1 more than the exclusive write sublock of lock L1. In such a case, the ratio associated with the one or more shared read sublock of lock L1 may be greater than the ratio associated with the exclusive write sublock of lock L1. The test application may have a randomizer which takes the ratios into account when randomly deciding whether to acquire the one or more shared read sublock or the exclusive write sublock of lock L1.

The test application set forth above in various embodiments in FIGS. 1-4 is advantageous because it can simulate real time and regular use of system 1 prior to use by the consumer. By simulating lock acquisition at a much higher rate than could be accomplished without the test application, system 1 may be tested and any faults or defects may be detected and fixed prior to shipping system 1 to the end user.

While the invention has been described in terms of several exemplary embodiments, those skilled in the art will recognize that the invention can be practiced with modification within the spirit and scope of the appended claims. Further, it is noted that, Applicant's intent is to encompass equivalents of all claim elements, even if amended later during prosecution.

1. A method of testing a system, comprising:
providing a shared memory including at least one value and at least one lock associated with the at least one value, the at least one lock including one or more shared read sublocks and an exclusive write sublock;
providing a plurality of subsystems in communication with the shared memory and configured to access and update the at least one value;
providing a test application on at least one of the plurality of subsystems; and
running the test application on the at least one of the plurality of subsystems,
wherein the test application comprises:
providing a predetermined list including a plurality of entries, each entry including a lock identification;
randomly choosing one of the plurality of entries;
randomly choosing one of one or more shared read sublocks and an exclusive write sublock of a lock associated with the lock identification of the one of the plurality of entries;
determining whether the one of the one or more shared read sublocks and the exclusive write sublock is available;
if the one of the one or more shared read sublocks and the exclusive write sublock is available, acquiring the one of the one or more shared read sublocks and the exclusive write sublock;
if the one of the one or more shared read sublocks and the exclusive write sublock is not available, waiting for the one of the one or more shared read sublocks and the exclusive write sublock to become available;
holding the one of the one or more shared read sublocks and the exclusive write sublock for a specific time; and
releasing the one of the one or more shared read sublocks and the exclusive write sublock;
wherein a list of locks and values given to the test application comprises a list of pre-existing locks and values in the system under said testing.
